(19) United States
(12) Patent Application Publication
(10) Pub. No.: US 2008/0250107 A1
(43) Pub. Date: Oct. 9, 2008

(54) INSTANT MESSAGE ARCHIVE VIEWING

(76) Inventors: Michael Holzer, San Jose, CA (US); Brian Kobashikawa, Mountain View, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/696,119

(22) Filed: Apr. 3, 2007

(51) Int. Cl. G06F 15/16

(52) U.S. Cl. 709/206

(57) ABSTRACT

Techniques for traversing a conversation history between a first user and a second user are provided. A window is displayed that is used to send messages from the second user to the first user. The window includes a conversation history window. The second user scrolls through the conversation history (associated with the first user) to find a particular message that was sent between the first user and the second user. In response, a plurality of capsules is displayed. Each capsule represents messages that were sent during a particular time period (e.g., a one month period). One or more of the capsules may be expanded to display: (a) additional capsules of finer time granularity (e.g., one week) or (b) actual messages. Each capsule may display text or graphics that clue the second user as to the messages that were sent during the time range represented by the corresponding capsule.

### FIELD OF THE INVENTION

The present invention relates to displaying a history of instant message messages.

### BACKGROUND

Instant messaging (or IM) is a form of real-time messages between two or more people based on typed text. The text is conveyed via computers connected over a network, such as the Internet.

IM typically requires the use of a client program that hooks up an instant messaging service. Alternatively, an IM service may be used via a browser using a web application. Examples of IM client programs include Yahoo! Messenger, AOL Instant Messenger, Google Talk, and Skype. IM differs from e-mail in that conversations occur in real-time. Most IM services offer a presence information feature, indicating whether people on a user's contact list are currently online and available to chat.

Typically, to initiate a conversation with a contact or “friend”, a user selects an icon representing the friend, which causes a conversation window to display. A conversation window typically includes a conversation history window and a text entry area. The text entry area displays a message that a user currently types but has not yet sent, whereas the conversation history window displays the messages sent to and received from the friend, at least since the conversation window has been opened.

However, the user may wish to see messages communicated with that friend before the conversation window was generated (i.e., prior to the current IM “session”). Some IM clients applications do not even provide an option to view previous messages (referred to hereinafter as “conversation history”) communicated outside the current conversation. (“Conversation history” refers at least to a subset of all previous IM conversations between a user and one or more contacts of the user.)

One approach for providing the user the ability to view a conversation history is to display automatically, whenever a new conversation window is opened, the conversation history of the previous 24 hours (between the user and the friend) in the conversation history window.

However, many times, a user may wish to see conversations that occurred days, months, or even years ago. Typical IM users have many conversations even within a month's time, which makes searching through a conversation history extremely cumbersome. Therefore, fetching all messages within, e.g., the last year for a friend and putting the messages in the conversation window would require a significant amount of memory every time a conversation window is displayed. Also, searching line by line through hundreds of plain text messages in a single window may prove unwieldy for the user. Furthermore, the scrollbar associated with the conversation history window may be rendered unhelpful if the conversation history is substantial. For example, under such circumstances, moving the thumb on the scrollbar a few pixels causes tens or hundreds of messages to be traversed.

In another approach for viewing previous IM conversations, an IM client application may have a “history” interface that is separate from the conversation window. The separate “history” interface may be a three-pane hierarchical design that divides the conversations up by contact, date, and then actual conversations.

However, under this approach, when a user wants to begin (or continue) a conversation with a friend, then the user has to change modes from a browse and view history mode to a current conversation mode by selecting a different window in order to converse with the friend. A disadvantage with this approach is that the user's experience suffers because the user has to manage two separate windows or interfaces.

Based on the foregoing, both approaches are deficient from a technological standpoint (i.e., unable to manage a large amount of data in a small space) and/or a user experience standpoint (i.e., requiring multiple interfaces). Thus, there is a need to provide a more user-friendly experience to allow a user to search intelligently for a small amount of data from a relatively substantial conversation history.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates how a conversation history may be viewed, according to an embodiment of the invention;

FIGS. 2A-H are block diagrams that illustrate how a conversation history may be viewed, according to an embodiment of the invention; and

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. For example, embodiments of the invention are described in the context of instant messaging. However, other contexts apply, such as email and mobile phones where a user wants to see the conversation history with respect to one or more of the user's contacts. In other instances, well-known structures and devices are shown in block diagram form in order to avoid unnecessarily obscuring the present invention.

### General Overview

Techniques are provided for allowing a user to search previous IM messages easily and efficiently. For example, while a user has a conversation window open for a particular contact of the user, the user may use a scrollbar of a conversation history window inside the same conversation window to view one or more previous messages communicated between the user and the particular contact, including messages communicated in prior “sessions”. By scrolling up to view messages that occurred further back in time, instead of viewing individual messages, the user views capsules that each represents multiple messages that were sent during a specific time range, such as April 2007. Each capsule may include information that indicates a significant event or message that occurred in the corresponding time range.

In one embodiment, if the user is satisfied with a subset of capsules that s/he views, then the user releases a thumb associated with a scrollbar, which results in expanding one or more capsules. Each of the expanded one or more capsules is replaced either by (a) additional capsules of lower time granularity or (b) text from actual messages communicated between the user and the particular contact. In this way, a user may efficiently search an entire conversation history (or message archive) without having to examine individual messages and without requiring an IM client application (or browser) to display megabytes of information each time a conversation window is opened.

### DEFINITIONS

As used hereinafter, a “message” is a transfer of information from one user to another user. The information may include text, images, audio, or video. The information may also include events that indicate presence. For example, an IM client application may detect that the user has been “idle” (i.e., not interacted with any application or message interface associated with the machine upon which the IM client application is executing) for 5 minutes. Being idle is an event that is sent to each of the user's contacts, or at least each “online” (i.e., currently signed in) contact. As additional examples of event, the user may indicate that s/he has “Stepped Out” or will return to his/her computer at a certain time.

Examples of events that do not indicate presence but could still be considered conversation history include, but are not limited to, a voice call, video call, sending of an emoticon, adding of the contact and including an introduction message, and sending a “Buzz” (as in Yahoo! Messenger).

As used hereinafter, a “conversation” is a set of messages between multiple users. A conversation may be delimited by time, by events, or by topic. For example, with respect to time, a conversation may be defined as a set of messages that occur within a single day. As another example, a conversation may be defined as a set of messages where a certain amount of time (e.g., three minutes) has elapsed since an immediately previous message was sent.

Examples of events that may delimit a conversation include, but are not limited to, closing a conversation window, logging out of the IM client application, and one of the users becoming idle.

A conversation is typically between two users. However, a conversation may be between more than two users simultaneously, in which each user is able to see the messages from each of the other users. Such an exchange of messages between more than two users is referred to hereinafter as a “conference.”

As used hereinafter, a “conversation history” is a set of conversations in which a user of an IM client has participated. Thus, a single conversation history may refer to previous conversations that the user has participated in (regardless of the participants) or to previous conversations with respect to a single contact in the user's contact list. In the latter case, if the user has conversed with multiple contacts, then there would be multiple conversation histories—one conversation history for each contact.

A conversation history may include a timestamp, either of the beginning of each conversation, the end of each conversation, and/or for each message in the conversation history.

As used hereinafter, and unless otherwise indicated, to “display” information, such as a conversation history or a portion thereof, does not necessarily indicate that the user is able to immediately see the information. Rather, “displaying” information indicates that the information is immediately available to be viewed in a window, even if scrolling the window is required. For example, under some circumstances, a portion of a conversation history is retrieved, either from local storage or from remote storage, and displayed in a conversation history window. In order for the user to view that retrieved portion, the user might need to scroll through the conversation history window. Therefore, under some circumstances, a conversation history window has a viewable portion and an unviewable portion. Messages received at the IM client may be “displayed” in either portion of the conversation history window.

### Capsules

According to an embodiment of the invention, a user views a conversation history at multiple levels of granularity. Viewing a conversation history at multiple levels of granularity may be achieved through the use of capsules.

A “capsule” is a graphic element in a conversation history window that represents a portion of a conversation history over a particular time range without showing all the messages that were sent during the particular time range. For example, a day capsule represents conversations that occurred during a particular day. A week capsule represents conversations that occurred during a particular week. A month capsule represents conversations that occurred during a particular month.

A capsule may indicate the particular time range that the capsule represents. For example, a day capsule for Oct. 16, 2006 may include the text “Oct. 16, 2006.”

A capsule, especially those at lower levels of time granularity (e.g., a week or a day), may include text that provides further information to the user about what messages were sent during that time range. The text may include portions of actual messages or a summary of actual messages. Messages that are abnormal or different from “normal” (e.g., simple text) messages in any way may be candidates for display in or with a capsule. An example of an abnormal message is a hypertext link to a website. Another example of an abnormal message is bolded, italicized, underlined, or color text. Yet another example of an abnormal message is the sending of a file (e.g., image, audio, or video file), in which case the text that is included with the capsule is the name of the file.

Capsules are expandable. Expanding a capsule (e.g., by selecting or “clicking on” the capsule) causes additional information about the messages, which were sent during the corresponding time range, to be displayed. For example, a month capsule may be expanded into 30 day capsules. Each day capsule may contain more information than the month capsule about actual messages that were sent during the corresponding day.

An advantage of capsules is that the scrollbar becomes manageable. Otherwise, if a conversation history window contained the entire conversation history, then the movement of the thumb of the scrollbar by even one pixel might cause hundreds of messages to be skipped.

### Traversing a Conversation History

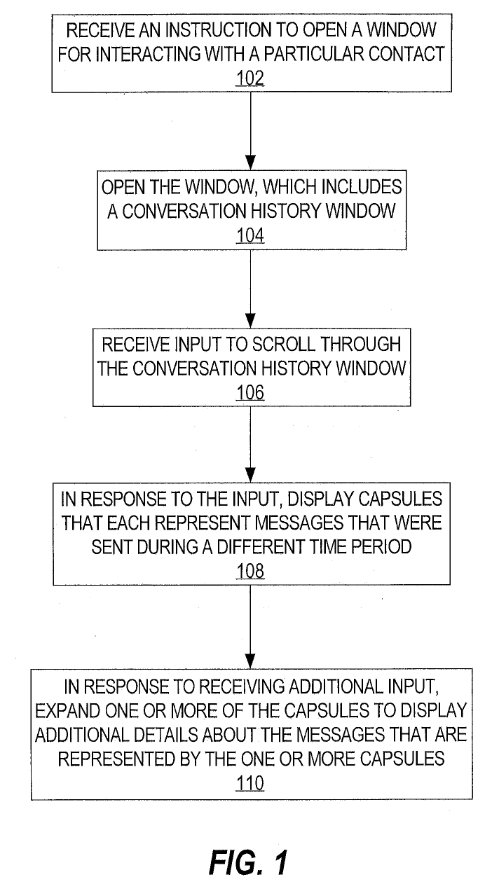

FIG. 1 is a flow diagram that illustrates how a conversation history may be viewed, according to an embodiment of the invention. The steps may be performed from the viewpoint of an instant messaging client. At step 102, an instruction to open a main window for interacting with a particular contact is received. At step 104, in response to the instruction, the main window is opened. The main window includes a conversation history window.

At step 106, input is received to scroll through the conversation history window. The input may be a mouse dragging a thumb of a scrollbar that is associated with the conversation history window. Alternatively, the input may be keyboard entries (such as arrow keys) that cause the conversation history window to scroll.

At step 108, in response to the input, multiple capsules, which each represent messages that were sent during a different time period, are displayed in the conversation history window. For example, each capsule in the set may represent messages that were sent during a different month.

At step 110, additional input is received that causes one or more of the capsules to be expanded. As a result of the expanded capsules, additional details about the messages that are represented by the one or more capsules are displayed in the conversation history window.

The additional input may be, for example, (a) the user selection of a button displayed in association with the conversation history window, (b) the user selection of one or more of the displayed capsules, or (c) a mouse release when the desired one or more capsules are displayed in the center of the viewable portion of the conversation history window.

The additional details include more detailed information about messages, sent during a particular time period, than the corresponding unexpanded capsule includes. For example, the capsules displayed in step 108 may only provide a few words from messages while the additional details may include the entire messages themselves.

### Scrollbar

Any mechanism for traversing through a conversation history may be used. According to an embodiment, the input received from a user to scroll through the conversation history is the movement of a thumb of a scrollbar associated with a conversation history window.

A scrollbar, or slider, is a graphical widget in a GUI with which continuous text, and pictures, including time in video applications, can be scrolled, i.e., viewed even if the information does not fit into the space in a computer display, window, or viewport. A scrollbar is typically designed as a long rectangular area on one or two sides of a viewing area. The scrollbar contains a bar (or “thumb”) that can be dragged along a trough (or “track”) to move the body of a document. The proportion of space that the thumb occupies on the scrollbar typically represents the portion of the data displayed in the window compared to all the data available.

However, in an embodiment, if the conversation history is quite large, then the granularity of the capsules changes the further back in the time dimension a user scrolls. Therefore, the proportion of the space that the thumb occupies on the scrollbar may change the further “up” the conversation history window the thumb goes. For example, initially, moving the thumb up may display each message sent during the current day. Then, as the thumb moves up farther, only a portion of each message sent during previous days might be shown. As the user continues to move the thumb upward, day capsules might be displayed. Subsequently, month capsules might be displayed until the user reaches the top of the scrollbar track which displays, for example, one or more year capsules.

### User Interface Examples

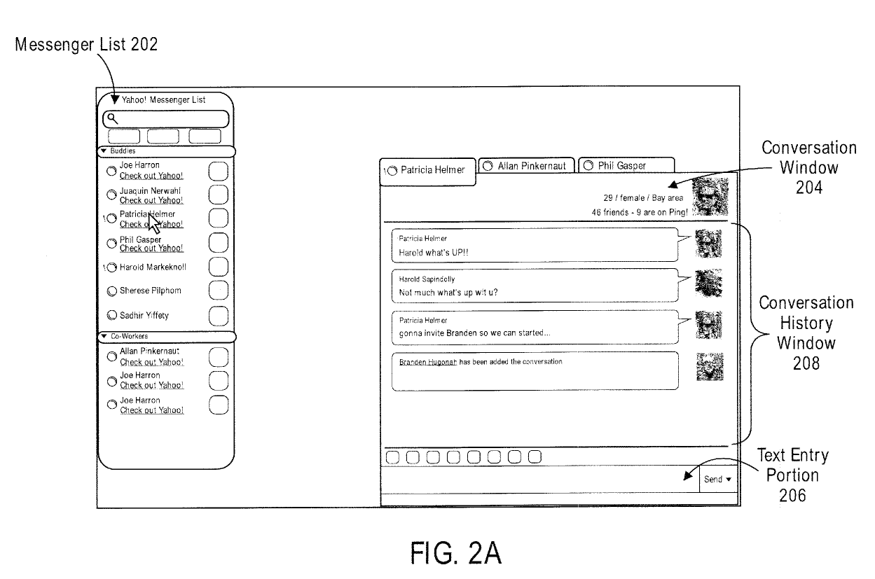

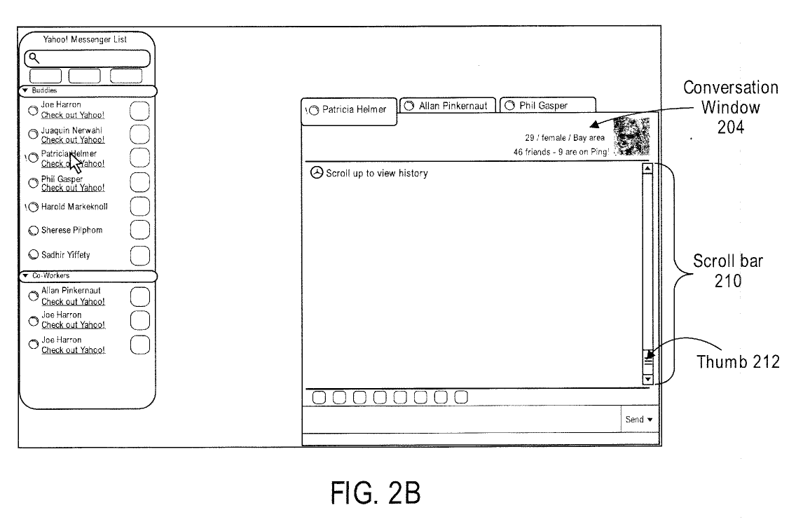

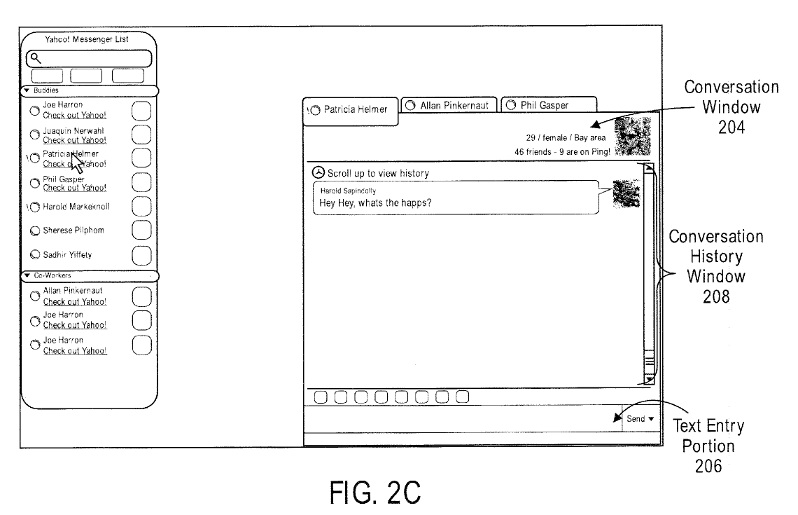

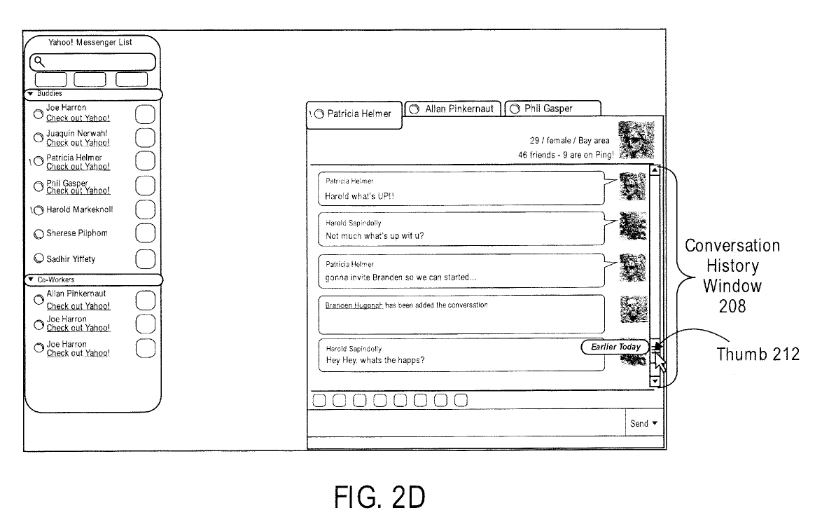

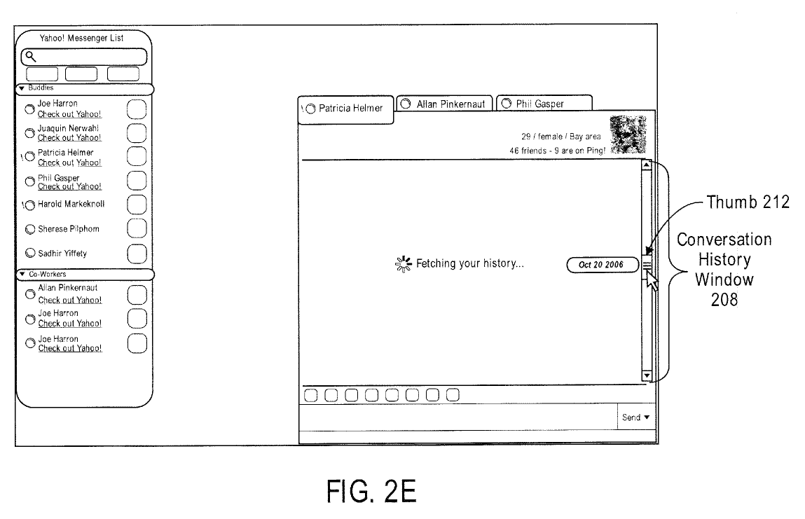

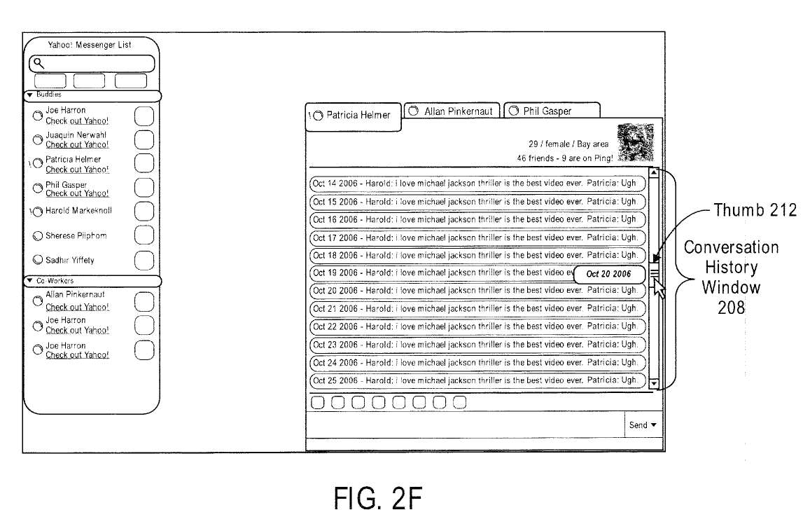

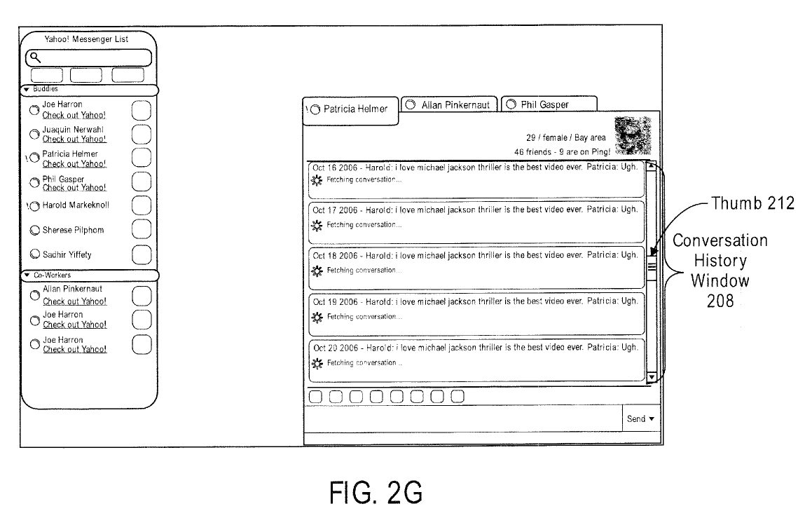

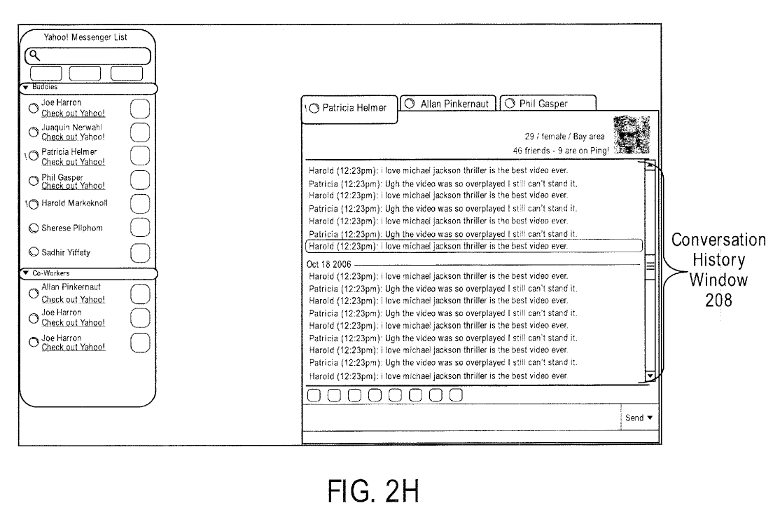

FIGS. 2A-H are block diagrams that illustrate how a conversation history may be viewed, according to an embodiment of the invention. FIG. 2A illustrates an IM client with an associated messenger list 202. In this example, the contact “Patricia Helmer” (referred to hereinafter simply as “the contact”) is selected from messenger list 202. In response, a conversation window 204 is opened. Conversation window 204 includes a text entry portion 206, in which the user of the IM client (referred to hereinafter simply as “the user”) enters text, and a conversation history window 208, in which a portion of the conversation history between the user and the contact is displayed.

Conversation windows can be displayed in response to other events as well. For example, in one embodiment, a conversation window is displayed in response to an IM client's receipt of an instant message from another user.

In this example, when conversation window 204 is first opened, the immediately previous messages communicated between the user and the contact are displayed for a short amount of time (e.g., 2 seconds) and then disappear. The number of previous messages that are displayed may be limited to the maximum number of messages that may be displayed simultaneously in the viewable portion of conversation history window 208.

FIG. 2B illustrates what conversation window 204 displays, either initially when conversation window 204 is opened by the user, or after the short amount of time (discussed above) elapses. The conversation window 204 of FIG. 2B includes a scrollbar 210 and a thumb 212 for scrolling through the conversation history between the user and the contact.

FIG. 2C illustrates the viewable portion of conversation history window 208 after text is entered in text entry portion 206. In this example, the user entered “Hey Hey, whats the happs?” After the text is sent to the contact, conversation history window 208 displays the text. A timestamp may accompany the text in conversation history window 208.

FIG. 2D illustrates the viewable portion of conversation history window 208 when the user scrolls up window 208 using a mouse pointer. The viewable portion of conversation history window 208 contains previous messages based on where thumb 212 is positioned in the associated trough, or track, of scrollbar 210. In this example, as thumb 212 is dragged upward, a time indicator (“Earlier today”) informs the user which portion of the conversation history will be shown in conversation history window 208 if thumb 212 does not continue moving.

As illustrated in FIG. 2D, the previous messages that occurred “Earlier today” are in a bubble format. Alternatively, previous messages may be displayed in a different format, such as a transcript format, as shown in FIG. 2H. For example, if the user scrolled up further (i.e., from the “Earlier today” position), then messages sent the previous day might be displayed in the transcript format. All such messages that were sent during that day may be visually contained in a distinguishable bubble that is associated with a day timestamp.

FIG. 2E illustrates the viewable portion of conversation history window 208 when the user scrolls further up window 208 to a time in the conversation history where the messages have not yet been fetched, or retrieved. In this example, a date is displayed that indicates to the user that if thumb 212 stops moving or is released (or the user performs some other action), then the conversation history (at least in capsule form) that occurred during the indicated date will be displayed.

Because there may be many megabytes of conversation history associated with the contact, the majority of the conversation history may be stored on one or more servers that are separate from the machine upon which the IM client is executing. Therefore, the user may see the “Fetching your history . . . ” message while the corresponding conversation history is retrieved from the one or more servers.

FIG. 2F illustrates the viewable portion of conversation history window 208 when the user has stopped moving thumb 212 and daily digest information for multiple days is displayed. In this example, the user has not yet released thumb 212. Also, twelve day capsules are displayed. Each day capsule includes a date in which messages were sent between the user and the contact. Because the thumb 212 stops moving when the day indicator bubble reads “Oct. 20, 2006”, the day capsule that represents the messages that were sent on Oct. 20, 2006 is centered in the viewable portion of conversation history window 208.

FIG. 2G illustrates the viewable portion of conversation history window 208 when the user releases thumb 212 while the day indicator bubble reads “Oct. 18, 2006”. The day capsules are expanded while the messages that correspond to each day capsule are fetched.

FIG. 2H illustrates the viewable portion of conversation history window 208 when the messages that correspond to the indicated day (i.e., Oct. 18, 2006) are fetched. In this example, the messages: (a) are displayed in a transcript format and (b) are individually timestamped. Each day is delimited with a separate date stamp. In an embodiment, all messages that were (a) communicated between the user and the contact and also (b) were sent during the date range when the user released thumb 212 (as explained with reference to FIG. 2G) are fetched so that if the user scrolls up or down, the viewable portion of conversation history window 208 will display those messages. In this example, messages that were sent from Oct. 16, 2006 through Oct. 20, 2006 are fetched and may be viewed by scrolling conversation history window 208. If the user scrolls to a point where the messages have not yet been fetched, then the process repeats beginning from FIG. 2E.

### Search Filters

According to an embodiment, a user may filter, or limit, the portion of the conversation history that is displayed in the conversation history window. For example, the user may enter a text string which is used to filter out (i.e., prevent from being displayed) capsules that do not “contain” all (or a subset) of the text string. In this context, a capsule “contains” text if one or more messages, that include the text, were sent during the corresponding time range.

The filter may also be used to filter actual messages that are displayed in the conversation history window when individual messages are displayed (i.e., at the lowest level of granularity).

### Hardware Overview

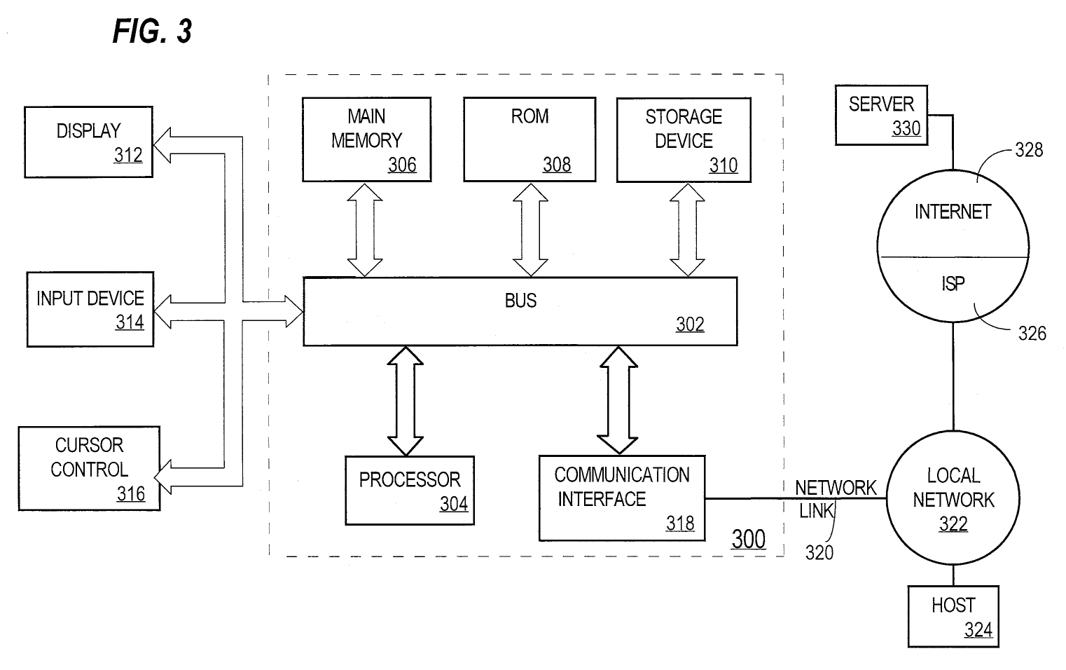

FIG. 3 is a block diagram that illustrates a computer system 300 upon which an embodiment of the invention may be implemented. Computer system 300 includes a bus 302 or other message mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data messages. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a message interface 318 coupled to bus 302. Message interface 318 provides a two-way data message coupling to a network link 320 that is connected to a local network 322. For example, message interface 318 may be an integrated services digital network (ISDN) card or a modem to provide a data message connection to a corresponding type of telephone line. As another example, message interface 318 may be a local area network (LAN) card to provide a data message connection to a compatible LAN. Wireless links may also be implemented. In any such implementation, message interface 318 sends and receives electrical, electromagnetic or optical signals that carry digital data streams representing various types of information.

Network link 320 typically provides data message through one or more networks to other data devices. For example, network link 320 may provide a connection through local network 322 to a host computer 324 or to data equipment operated by an Internet Service Provider (ISP) 326. ISP 326 in turn provides data message services through the world wide packet data message network now commonly referred to as the “Internet” 328. Local network 322 and Internet 328 both use electrical, electromagnetic or optical signals that carry digital data streams. The signals through the various networks and the signals on network link 320 and through message interface 318, which carry the digital data to and from computer system 300, are exemplary forms of carrier waves transporting the information.

Computer system 300 can send messages and receive data, including program code, through the network(s), network link 320 and message interface 318. In the Internet example, a server 330 might transmit a requested code for an application program through Internet 328, ISP 326, local network 322 and message interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of displaying a conversation history that is associated with a first user and a second user of an instant messaging service, the method comprising:
opening a conversation history window;
receiving first input that indicates the second user's intent to scroll through the conversation history window;
in response to the first input, displaying a first portion of the conversation history in the conversation history window;
wherein the conversation history comprises a plurality of communications that were sent between the first user and the second user using the instant messaging service;
wherein the first portion represents a subset of the plurality of communications that were sent during a particular time period, wherein the first portion excludes data from the subset;
in response to receiving second input, displaying a second portion of the conversation history in the conversation history window;
wherein the second portion represents a particular subset of the subset, wherein the second portion includes more data from the particular subset than the first portion.

2. The method of claim 1, wherein the plurality of communications include at least one of (1) text messages, (2) names of files that have been sent between the second user and the first user using the instant messaging service, and (3) events associated with at least one of the first user or the second user.

3. The method of claim 1, wherein displaying the first portion of the conversation history includes retrieving the first portion from one or more servers over a network.

4. The method of claim 1, wherein:
a mouse is used to scroll through the conversation history window; and
the second input is releasing a button of the mouse.

5. The method of claim 1, wherein:
the first portion of the conversation history is represented by a plurality of capsules that each represents a particular set of communications that were sent during a different portion of the particular time period; and
the second input is selecting one or more of the plurality of capsules.

6. The method of claim 1, wherein the plurality of communications comprise all the communications that were sent between the first user and the second user using the instant messaging service.

7. The method of claim 1, wherein the set of communications includes communications that were sent to and from a third user, using the instant messaging service, during a conference conversation that included the first, second, and third users.

8. The method of claim 1, wherein receiving the first input includes:
displaying a first plurality of capsules in the conversation history window, wherein each capsule, of the first plurality of capsules, represents a set of communications that were sent during a different time period, wherein the length of the time period for each capsule of the first plurality is the same for each other capsule of the first plurality; and
in response to detecting additional scrolling through the conversation history window, displaying a second plurality of capsules in the conversation history window, wherein each capsule, of the second plurality of capsules, represents a set of communications that were sent during a different time period, wherein the length of the time period for each capsule in the second plurality of capsules is longer than the length of the time period for each capsule in the first plurality of capsules.

9. The method of claim 1, wherein opening the conversation history window includes opening a particular window for interacting with the first user, wherein the particular window includes the conversation history window.

10. The method of claim 1, wherein the plurality of communications were sent between an instant messaging client of the first user and an instant messaging client of the second user.

11. A method of displaying a conversation history that is associated with a first user and a second user of a messaging service, the method comprising:
receiving an instruction to open a window for interacting with the first user;
in response to receiving the instruction, opening the window, wherein the window includes a conversation history window;
receiving first input that indicates the second user's intent to scroll through the conversation history window;
in response to the first input, displaying a first portion of the conversation history in the conversation history window;
wherein the conversation history comprises a plurality of communications that were sent between the first user and the second user using the messaging service;
wherein the first portion represents a subset of the plurality of communications that were sent during a particular time period, wherein the first portion excludes data from the subset;
in response to receiving second input, displaying a second portion of the conversation history in the conversation history window;
wherein the second portion represents a particular subset of the subset, wherein the second portion includes more data from the particular subset than the first portion.

12. The method of claim 11, wherein the messaging service is one of an instant messaging service or an email service.

13. The method of claim 1, wherein the plurality of communications were sent between a messaging client of the first user and a messaging client of the second user.

14. A method of displaying a conversation history associated with a user of an instant messaging service, the method comprising:
opening a conversation history window;
receiving first input that indicates the second user's intent to scroll through the conversation history window;
in response to the first input, displaying a first portion of the conversation history in the conversation history window;
wherein the conversation history comprises a plurality of communications that were sent between the user and multiple other users that use the instant messaging service;
wherein the first portion represents a subset of the plurality of communications that were sent during a particular time period, wherein the first portion excludes data from the set of communications;
in response to receiving second input, displaying a second portion of the conversation history in the conversation history window;
wherein the second portion represents a particular subset of the subset, wherein the second portion includes more data from the particular subset than the first portion.

15. A machine-readable medium carrying one or more sequences of instructions which, when executed by one or more processors, causes the one or more processors to perform the method recited in claim 1.

16. A machine-readable medium carrying one or more sequences of instructions which, when executed by one or more processors, causes the one or more processors to perform the method recited in claim 2.

17. A machine-readable medium carrying one or more sequences of instructions which, when executed by one or more processors, causes the one or more processors to perform the method recited in claim 3.

18. A machine-readable medium carrying one or more sequences of instructions which, when executed by one or more processors, causes the one or more processors to perform the method recited in claim 4.

19. A machine-readable medium carrying one or more sequences of instructions which, when executed by one or more processors, causes the one or more processors to perform the method recited in claim 5.

20. A machine-readable medium carrying one or more sequences of instructions which, when executed by one or more processors, causes the one or more processors to perform the method recited in claim 6.

21. A machine-readable medium carrying one or more sequences of instructions which, when executed by one or more processors, causes the one or more processors to perform the method recited in claim 7.

22. A machine-readable medium carrying one or more sequences of instructions which, when executed by one or more processors, causes the one or more processors to perform the method recited in claim 8.

23. A machine-readable medium carrying one or more sequences of instructions which, when executed by one or more processors, causes the one or more processors to perform the method recited in claim 9.

24. A machine-readable medium carrying one or more sequences of instructions which, when executed by one or more processors, causes the one or more processors to perform the method recited in claim 10.

25. A machine-readable medium carrying one or more sequences of instructions which, when executed by one or more processors, causes the one or more processors to perform the method recited in claim 11.

26. A machine-readable medium carrying one or more sequences of instructions which, when executed by one or more processors, causes the one or more processors to perform the method recited in claim 12.

27. A machine-readable medium carrying one or more sequences of instructions which, when executed by one or more processors, causes the one or more processors to perform the method recited in claim 13.

28. A machine-readable medium carrying one or more sequences of instructions which, when executed by one or more processors, causes the one or more processors to perform the method recited in claim 14.
